(19) United States
(12) Patent Application Publication
(10) Pub. No.: US 2012/0253648 A1
(43) Pub. Date: Oct. 4, 2012

(54) APPARATUS AND METHOD FOR GENERATING TRAFFIC INFORMATION

(75) Inventors: Do-Hyun KIM, Daejeon (KR); Jong-Hyun PARK, Daejeon (KR); Jae-Jun YOO, Daejeon (KR); Kyong-Ho KIM, Daejeon (KR)

(73) Assignee: ELECTRONICS AND TELECOMMUNICATIONS RESEARCH INSTITUTE, Daejeon-City (KR)

(21) Appl. No.: 13/435,564

(22) Filed: Mar. 30, 2012

(30) Foreign Application Priority Data
Apr. 1, 2011 (KR) 10-2011-0030265
Dec. 14, 2011 (KR) 10-2011-0134850

(51) Int. Cl. G08G 1/00

(52) U.S. Cl. 701/119

(57) ABSTRACT

Disclosed herein are an apparatus and method for generating traffic information. The apparatus includes a first information collection unit, a second information collection unit, a comparison and analysis unit, and a computation unit. The first information collection unit collects first sensed data, including first reference sampled data and a plurality of pieces of first surrounding sampled data from a first sensor unit. The second information collection unit collects second sensed data, including second reference sampled data and a plurality of pieces of second surrounding sampled data from a second sensor unit. The comparison and analysis unit determines similarity between the first sensed data and the second sensed data, extracts a first time from the first sensed data, and extracts a second time from the second sensed data. The computation unit calculates the vehicle's average speed.

### CROSS-REFERENCE TO RELATED ED APPLICATIONS

This application claims the benefit of Korean Patent Application No. 10-2011-0030265, filed on Apr. 1, 2011, and Korean Patent Application No. 10-2011-0134850, filed on Dec. 14, 2011, which are hereby incorporated by reference in their entirety into this application.

### BACKGROUND OF THE INVENTION

1. Technical Field

The present invention relates generally to an apparatus and method for generating traffic information and, more particularly, to an apparatus and method for generating traffic information that are capable of improving the accuracy of the collection of traffic information while minimizing the power consumption of sensor units.

2. Description of the Related Art

Current traffic conditions are very poor because of rapidly increasing traffic demands and road conditions that do not meet the demands. In order to mitigate the poor conditions, it is necessary to accurately and stably collect traffic information (speeds, volumes of traffic, types of vehicles, etc.), which is basic intelligence that is very essential to the efficient operation and management of existing roads and to the planning, designing, and operation of roads to be newly constructed.

In general, methods for acquiring vehicle information on a road to support smooth traffic flow include an image detection method using a video camera, a detection method using ultrasonic waves or a laser, and a method of collecting traffic information using geomagnetic sensors installed on a traffic lane.

Of these methods, the method using geomagnetic sensors is configured to collect traffic information by detecting variations in geomagnetism, which are generated by a vehicle, and is implemented by the following two methods. The first method determines the times at which a vehicle enters and exits at geomagnetic sensor nodes and then generates traffic information using the corresponding information. The second method continuously detects variations in geomagnetism in the period from the entry of a vehicle to the exit of the vehicle and generates traffic information by analyzing the detected data.

However, the first method has a problem that it is difficult to accurately detect the times at which a vehicle enters and exits when there is a difference in sensitivity between geomagnetic sensors installed on a traffic lane. Furthermore, the second method has the problem of excessive power consumption attributable to an excessive amount of work at the geomagnetic sensor nodes.

### SUMMARY OF THE INVENTION

Accordingly, the present invention has been made keeping in mind the above problems occurring in the prior art, and an object of the present invention is to provide an apparatus and method for generating traffic information that are capable of improving the accuracy of the collection of traffic information while minimizing the power consumption of sensor units.

That is, an object of the present invention is to provide an apparatus and method for generating traffic information that are capable of preventing the time at which a vehicle passed from being inaccurately measured because of a difference in sensitivity between geomagnetic sensors.

In order to accomplish the above object, the present invention provides an apparatus for generating traffic information, including a first information collection unit for collecting first sensed data, including first reference sampled data related to detection of information about a vehicle and a plurality of pieces of first surrounding sampled data obtained before and after the first reference sampled data, from a first sensor unit that samples variations in geomagnetism at a first point of a traffic lane at predetermined intervals; a second information collection unit for collecting second sensed data, including second reference sampled data related to detection of information about the vehicle and a plurality of pieces of second surrounding sampled data obtained before and after the second reference sampled data, from a second sensor unit that samples variations in geomagnetism at a second point of the traffic lane at predetermined intervals; a comparison and analysis unit for determining similarity between the first sensed data and the second sensed data by comparing them with each other, extracting a first time at which the vehicle passed the first sensor unit from the first sensed data, and extracting a second time at which the vehicle passed the second sensor unit, corresponding to the first time, from the second sensed data; and a computation unit for calculating the vehicle's average speed using information about the first time and the second time.

The first information collection unit may collect the first sensed data based on a section in which the vehicle had entered the first sensor unit; the second information collection unit may collect the second sensed data based on a section in which the vehicle had entered the second sensor unit; and the comparison and analysis unit may extract the time at which the vehicle entered the first sensor unit as the first time, and extracts the time at which the vehicle entered the second sensor unit as the second time.

The first information collection unit may collect the first sensed data based on a section in which the vehicle had exited from the first sensor unit; the second information collection unit may collect the second sensed data based on a section in which the vehicle had exited from the second sensor unit; and the comparison and analysis unit may extract the time at which the vehicle exited from the first sensor unit as the first time, and extracts the time at which the vehicle exited from the second sensor unit as the second time.

The first information collection unit may collect the first sensed data using a greatest one of the sensed values varying while the vehicle was passing the first sensor unit, as the first reference sampled data; and the second information collection unit may collect the second sensed data using a greatest one of the sensed values, varying while the vehicle was passing the second sensor unit, as the second reference sampled data.

The first information collection unit, the second information collection unit and the comparison and analysis unit may perform a first technique that extracts times at which the vehicle entered the first sensor unit and the second sensor unit as the first time and the second time, respectively, and calculates the vehicle's average speed, a second technique that extracts times at which the vehicle exited from the first sensor unit and the second sensor unit as the first time and the second time, respectively, and calculates the vehicle's average speed, and a third technique that extracts times at which greatest sensed values caused by the vehicle were detected by the first sensor unit and the second sensor unit as the first time and the second time, respectively, and calculates the vehicle's average speed; and the computation unit may calculate the vehicle's final average speed by comparing similarities among the vehicle's average speeds calculated by the first, second and the third techniques.

The computation unit may calculate an average of the vehicle's two remaining average speeds, obtained by excluding a most different one from the vehicle's average speeds calculated by the first, second and third techniques, as the vehicle's final average speed.

In order to accomplish the above object, the present invention provides a method of generating traffic information, including collecting first sensed data, including first reference sampled data related to detection of information about a vehicle and a plurality of pieces of first surrounding sampled data obtained before and after the first reference sampled data, from a first sensor unit that samples variations in geomagnetism at a first point of a traffic lane at predetermined intervals; collecting second sensed data, including second reference sampled data related to detection of information about the vehicle and a plurality of pieces of second surrounding sampled data obtained before and after the second reference sampled data, from a second sensor unit that samples variations in geomagnetism at a second point of the traffic lane at predetermined intervals; extracting a first time at which the vehicle passed the first sensor unit from the first sensed data; determining similarity between the first sensed data and the second sensed data by comparing them with each other, and extracting a second time at which the vehicle passed the second sensor unit, corresponding to the first time, from the second sensed data; and calculating the vehicle's average speed using information about the first time and the second time.

The collecting first sensed data may include collecting the first sensed data based on a section in which the vehicle had entered the first sensor unit; the collecting second sensed data may include collecting the second sensed data based on a section in which the vehicle had entered the second sensor unit; the extracting first time may include extracting the time at which the vehicle entered the first sensor unit as the first time; and the extracting second time may include extracting the time at which the vehicle entered the second sensor unit as the second time.

The collecting first sensed data may include collecting the first sensed data based on a section in which the vehicle had exited from the first sensor unit; the collecting second sensed data may include collecting the second sensed data based on a section in which the vehicle had exited from the second sensor unit; the extracting first time may include extracting the time at which the vehicle exited from the first sensor unit as the first time; and the extracting second time may include extracting the time at which the vehicle exited from the second sensor unit as the second time.

The collecting first sensed data may include collecting the first sensed data using a greatest one of the sensed values varying while the vehicle was passing the first sensor unit, as the first reference sampled data; and the collecting second sensed data may include collecting the second sensed data using a greatest one of the sensed values, varying while the vehicle was passing the second sensor unit, as the second reference sampled data.

The collecting first sensed data, the collecting second sensed data, the extracting first time, and the extracting second time may be performed using a first technique that extracts times at which the vehicle entered the first sensor unit and the second sensor unit as the first time and the second time, respectively, and calculates the vehicle's average speed, a second technique that extracts times at which the vehicle exited from the first sensor unit and the second sensor unit as the first time and the second time, respectively, and calculates the vehicle's average speed, and a third technique that extracts times at which greatest sensed values caused by the vehicle were detected by the first sensor unit and the second sensor unit as the first time and the second time, respectively, and calculates the vehicle's average speed; and the calculating the vehicle's average speed may include calculating the vehicle's final average speed by comparing similarities among the vehicle's average speeds calculated by the first, second and the third techniques.

The calculating the vehicle's average speed may include calculating an average of the vehicle's two remaining average speeds, obtained by excluding a most different one from the vehicle's average speeds calculated by the first, second and third techniques, as the vehicle's final average speed.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating an apparatus for generating traffic information according to a first embodiment of the present embodiment; and

FIG. 2 is a flowchart illustrating a method of generating traffic information according to the present invention.

### DESCRIPTION OF THE PREFERRED EMBODIMENTS

Reference now should be made to the drawings, throughout which the same reference numerals are used to designate the same or similar components.

The present invention will be described in detail below with reference to the accompanying drawings. Repeated descriptions and descriptions of known functions and constructions which have been deemed to make the gist of the present invention unnecessarily vague will be omitted below. The embodiments of the present invention are provided in order to fully describe the present invention to a person having ordinary skill in the art. Accordingly, the shapes, sizes, etc. of elements in the drawings may be exaggerated to make the description clear.

The configuration and operation of an apparatus for generating traffic information according to a first embodiment of the present invention will be described in detail below.

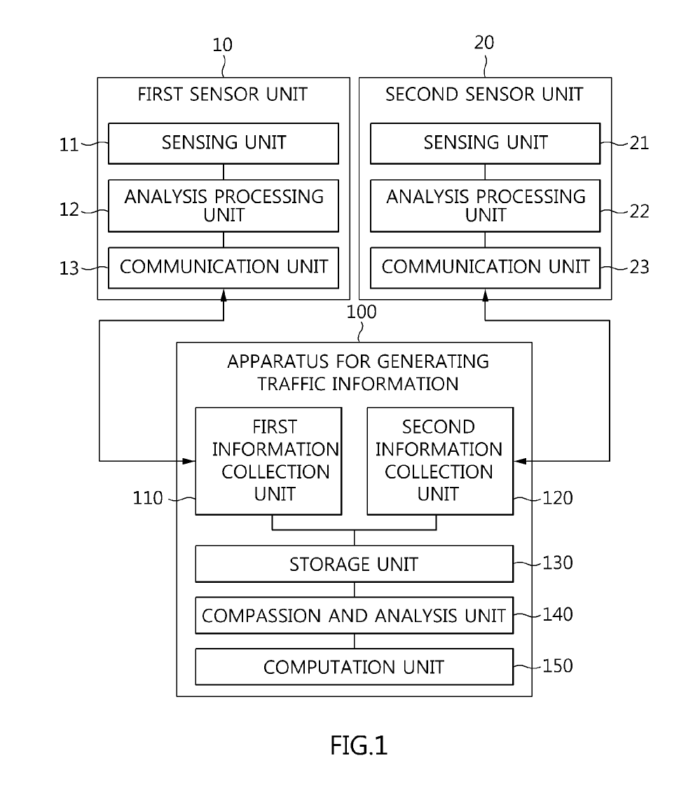

FIG. 1 is a block diagram illustrating the apparatus for generating traffic information according to the present embodiment.

Referring to FIG. 1, the apparatus 100 for generating traffic information according to the present embodiment is connected to a first sensor unit 10 and a second sensor unit 20 so that data can be sent and received via a wired or wireless connection.

The first sensor unit 10 is installed at a first point of a traffic lane, and may be operated under the wired or wireless control of the apparatus 100 for generating traffic information. The first sensor unit 10 includes a sensing unit 11, an analysis processing unit 12, and a communication unit 13. The sensing unit 11 samples, at predetermined intervals, variations in geomagnetism that occur while a vehicle is passing it. That is, the sensing unit 11 does not continuously detect variations in geomagnetism, but detects variations in geomagnetism at predetermined intervals. The analysis processing unit 12 detects information about the vehicle by analyzing the data detected by the sensing unit 11. The communication unit 13 functions to receive control signals from the apparatus 100 for generating traffic information and send the data, detected by the analysis processing unit 12, to the apparatus 100 for generating traffic information.

The second sensor unit 20 is installed at a second point of the traffic lane, and may be operated under the wired or wireless control of the apparatus 100 for generating traffic information. Here, the second point corresponds to a point having a strong possibility of the vehicle having passed the first sensor unit 10 passing it. The second sensor unit 20 includes a sensing unit 21, an analysis processing unit 22, and a communication unit 23. The sensing unit 21 samples, at predetermined intervals, variations in geomagnetism that occur while the vehicle is passing it. That is, the sensing unit 21 does not continuously detect variations in geomagnetism, but detects variations in geomagnetism at predetermined intervals. The analysis processing unit 22 detects information about the vehicle by analyzing the data detected by the sensing unit 21. The communication unit 23 functions to receive control signals from the apparatus 100 for generating traffic information, and to send the data, detected by the analysis processing unit 22, to the apparatus 100 for generating traffic information.

The apparatus 100 for generating traffic information may include a first information collection unit 110, a second information collection unit 120, a storage unit 130, a comparison and analysis unit 140, and a computation unit 150.

The first information collection unit 110 collects first sensed data, including first reference sampled data related to the detection of information about the vehicle and a plurality of pieces of first surrounding sampled data obtained before and after the first reference sampled data, from the first sensor unit 10. In this case, the first information collection unit 110 may collect the first sensed data based on the section of the data about variations in geomagnetism data in which the vehicle had entered the first sensor unit 10.

The second information collection unit 120 collects second sensed data, including second reference sampled data related to the detection of information about the vehicle and a plurality of pieces of first surrounding sampled data obtained before and after the second reference sampled data, from the second sensor unit 20. In this case, the second information collection unit 120 may collect the second sensed data based on the section of data about variations in geomagnetism in which the vehicle had entered the second sensor unit 20.

The first information collection unit 110 and the second information collection unit 120 do not continuously collect the continuous data of the geomagnetic sensors, but collect the data of the geomagnetic sensors which is sampled at predetermined intervals, thereby minimizing power consumption.

The storage unit 130 stores the data collected by the first information collection unit 110 and the second information collection unit 120.

The comparison and analysis unit 140 determines similarity between the first sensed data collected by the first information collection unit 110 and the second sensed data collected by the second information collection unit 120 by comparing them with each other. Furthermore, the comparison and analysis unit 140 extracts the first time at which the vehicle passes the first sensor unit 10, that is, at which the vehicle entered the first sensor unit 10, from the first sensed data. Furthermore, the comparison and analysis unit 140 extracts the second time at which the vehicle passes the second sensor unit 20, that is, at which the vehicle entered the second sensor unit 20, from the second sensed data. In this case, the comparison and analysis unit 140 extracts the second time corresponding to the first time using the similarity data. That is, the comparison and analysis unit 140 detects the time at which the vehicle entered while preventing an error attributable to a difference in sensitivity between the first sensor unit 10 and the second sensor unit 20 using the similarity data. Furthermore, the comparison and analysis unit 140 may acquire traffic information, such as information about traffic on the traffic lane where the first sensor unit 10 and the second sensor unit 20 were installed, by analyzing the data stored in the storage unit 130.

The computation unit 150 calculates the vehicle's average speed using the times at which the vehicle entered, that is, the first time and the second time, detected by the comparison and analysis unit 140. In greater detail, the computation unit 150 calculates the vehicle's average speed using the following Equation 1:

$$Vehicle ' s average speed = \frac{second time - first time}{distance between first sensor unit and second sensor unit} \qquad ( 1 )$$

The operation in which the apparatus 100 for generating traffic information calculates a vehicle's average speed according to a second embodiment of the present invention will be described in detail below.

The first information collection unit 110 collects first sensed data based on the section of data about variations in geomagnetism in which the vehicle had exited from the first sensor unit 10.

The second information collection unit 120 collects second sensed data based on the section of data about variations in geomagnetism in which the vehicle had exited from the second sensor unit 20.

The comparison and analysis unit 140 extracts the first time at which the vehicle exited from the first sensor unit 10 from the first sensed data. Furthermore, the comparison and analysis unit 140 extracts the second time at which the vehicle exited from the second sensor unit 20 from the second sensed data. In this case, the comparison and analysis unit 140 extracts the second time corresponding to the first time using similarity data.

The computation unit 150 calculates the vehicle's average speed using the times at which the vehicle exited, that is, the first time and the second time, detected by the comparison and analysis unit 140.

The operation of the apparatus for generating traffic information according to a third embodiment of the present invention will be described in detail below.

The first information collection unit 110 collects first sensed data using the greatest of sensed geomagnetic values, varying while the vehicle was passing the first sensor unit 10, as first reference sampled data.

The second information collection unit 120 collects second sensed data using the greatest of sensed geomagnetic values, varying while the vehicle was passing the second sensor unit 20, as second reference sampled data.

The comparison and analysis unit 140 extracts the time at which the greatest of the sensed geomagnetic values of the first sensed data occurred as the first time. Furthermore, the comparison and analysis unit 140 extracts the second time corresponding to the first time of the sensed geomagnetic values of the second sensed data using data about similarity between the first sensed data and the second sensed data. That is, the comparison and analysis unit 140 extracts the times at which the specific portion (the portion for which the sensed geomagnetic value was greatest) of the vehicle passes the first sensing unit 10 and the second sensing unit 20 as the first time and the second time using data about similarity in light of data to allow for the case when there is a difference in sensitivity between the first sensing unit 10 and the second sensing unit 20.

The operation of the apparatus for generating traffic information according to a fourth embodiment of the present invention will be described in detail below.

The apparatus for generating traffic information according to the fourth embodiment of the present invention may calculate the vehicle's final average speed by comparing similarities among the vehicle's average speeds calculated by the first, second, and third embodiments.

In greater detail, the first information collection unit 110, the second information collection unit 120, and the comparison and analysis unit 140 calculate a vehicle's average speed using the following three techniques.

The first technique is a technique that extracts the times at which the vehicle entered the first sensor unit 10 and the second sensor unit 20 as the first time and the second time, respectively, and calculates the vehicle's average speed.

The second technique extracts the times at which the vehicle exited from the first sensor unit 10 and the second sensor unit 20 as the first time and the second time, and calculates the vehicle's average speed.

The third technique is a technique that extracts the times at which the sensed value is most greatly varied by the vehicle in the first sensor unit 10 and the second sensor unit 20 as the first time and the second time, respectively, and calculates the vehicle's average speed.

Thereafter, the computation unit 150 calculates the final average speed of the vehicle by determining similarities among the vehicle's average speeds calculated by the first, second, and third techniques by comparing them with one another. In greater detail, the computation unit 150 excludes the most different one of the vehicle's average speeds calculated by the first, second, and third techniques. Furthermore, the computation unit 150 calculates the average of the vehicle's average speeds calculated by the remaining two techniques as the vehicle's final average speed. By doing so, the accuracy of the calculation of the vehicle's average speed can be further improved.

A method of generating traffic information according to the present invention will be described in detail below.

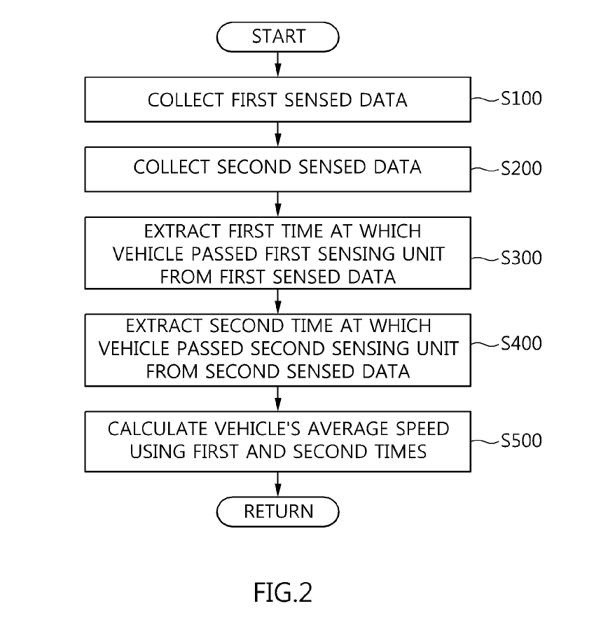

FIG. 2 is a flowchart illustrating a method of generating traffic information according to the present invention.

Referring to FIG. 2, in the method of generating traffic information according to the present invention, first sensed data is collected from the first sensor unit that samples variations in geomagnetism at the first point of a traffic lane at predetermined intervals at step S100. Here, the first sensed data includes first reference sampled data related to the detection of information about the vehicle and a plurality of pieces of first surrounding sampled data obtained before and after the first reference sampled data.

Second sensed data is collected from the second sensor unit that samples variations in geomagnetism at the second point of a traffic lane at predetermined intervals at step S200. Here, the second sensed data includes second reference sampled data related to the detection of information about the vehicle and a plurality of pieces of first surrounding sampled data obtained before and after the second reference sampled data.

Thereafter, at step S300, the first time at which the vehicle passed the first sensor unit is extracted from the first sensed data detected at step S100.

Furthermore, at step S400, the second time at which the vehicle passed the second sensor unit is extracted from the second sensed data detected at step S200.

Thereafter, at step S500, the corresponding vehicle's average speed is calculated using information about the first time and the second time extracted at steps S300 and S400.

In greater detail, in the first technique of the method of generating traffic information according to the present invention, first sensed data is collected based on the section in which the vehicle had entered the first sensor unit at step S100. Furthermore, at step S200, second sensed data is collected based on the section in which the vehicle had entered the second sensor unit. Furthermore, the time at which the vehicle entered the first sensor unit is extracted as the first time at step S300, and the second time at which the vehicle entered the second sensor unit, corresponding to the first time, is extracted at step S400.

Furthermore, in the second technique of the method of generating traffic information according to the present invention, first sensed data is collected based on the section in which the vehicle had exited from the first sensor unit at step S100. Furthermore, second sensed data is collected based on the section in which the vehicle had exited from the second sensor unit at step S200. Moreover, the time at which the vehicle exited from the first sensor unit is extracted as the first time at step S300, and the second time at which the vehicle exited from the second sensor unit, corresponding to the first time, is extracted at step S400.

Moreover, in the third technique of the method of generating traffic information according to the present invention, first sensed data is collected using the greatest of sensed values, varying while the vehicle was passing the first sensor unit, as first reference sampled data at step S100. Furthermore, second sensed data is collected using the greatest of sensed values, varying while the vehicle was passing the second sensor unit, as second reference sampled data at step S200. Furthermore, the time at which the greatest of the sensed geomagnetic values of the first sensed data occurred is extracted as the first time at step S300. Furthermore, the second time of the sensed geomagnetic values of the second sensed data, corresponding to the first time, is extracted at step S400. That is, the times at which the same specific portion (the portion where the greatest sensed geomagnetic value occurred) of the vehicle passed the first sensing unit and the second sensing unit are extracted as the first time and the second time, respectively, using data about similarities between the first sensed data and the second sensed data.

Moreover, in the method of generating traffic information according to the present invention, the vehicle's final average speed may be calculated by comparing similarities among the vehicle's average speeds calculated by the first, second, and third techniques. In greater detail, the most different one of the vehicle's average speeds calculated by the first, second, and third techniques is excluded at step S500. Furthermore, the average of the vehicle's average speeds calculated by the remaining two techniques is calculated as the vehicle's final average speed at step S500. By doing so, the accuracy of the calculation of the vehicle's average speed can be further improved.

As described above, the present invention has the advantage of improving the accuracy of the collection of traffic information while minimizing the power consumption of sensor units. That is, the present invention has the advantage of preventing the time at which a vehicle passed from being inaccurately measured because of a difference in sensitivity between geomagnetic sensors.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for generating traffic information, comprising:
a first information collection unit for collecting first sensed data, including first reference sampled data related to detection of information about a vehicle and a plurality of pieces of first surrounding sampled data obtained before and after the first reference sampled data, from a first sensor unit that samples variations in geomagnetism at a first point of a traffic lane at predetermined intervals;
a second information collection unit for collecting second sensed data, including second reference sampled data related to detection of information about the vehicle and a plurality of pieces of second surrounding sampled data obtained before and after the second reference sampled data, from a second sensor unit that samples variations in geomagnetism at a second point of the traffic lane at predetermined intervals;
a comparison and analysis unit for determining similarity between the first sensed data and the second sensed data by comparing them with each other, extracting a first time at which the vehicle passed the first sensor unit from the first sensed data, and extracting a second time at which the vehicle passed the second sensor unit, corresponding to the first time, from the second sensed data; and
a computation unit for calculating the vehicle's average speed using information about the first time and the second time.

2. The apparatus of claim 1, wherein:
the first information collection unit collects the first sensed data based on a section in which the vehicle had entered the first sensor unit;
the second information collection unit collects the second sensed data based on a section in which the vehicle had entered the second sensor unit; and
the comparison and analysis unit extracts a time at which the vehicle entered the first sensor unit as the first time, and extracts a time at which the vehicle entered the second sensor unit as the second time.

3. The apparatus of claim 1, wherein:
the first information collection unit collects the first sensed data based on a section in which the vehicle had exited from the first sensor unit;
the second information collection unit collects the second sensed data based on a section in which the vehicle had exited from the second sensor unit; and
the comparison and analysis unit extracts a time at which the vehicle exited from the first sensor unit as the first time, and extracts a time at which the vehicle exited from the second sensor unit as the second time.

4. The apparatus of claim 1, wherein:
the first information collection unit collects the first sensed data using a greatest one of the sensed values, varying while the vehicle was passing the first sensor unit, as the first reference sampled data; and
the second information collection unit collects the second sensed data using a greatest one of the sensed values, varying while the vehicle was passing the second sensor unit, as the second reference sampled data.

5. The apparatus of claim 1, wherein the first information collection unit, the second information collection unit and the comparison and analysis unit performs:
a first technique that extracts times at which the vehicle entered the first sensor unit and the second sensor unit as the first time and the second time, respectively, and calculates the vehicle's average speed,
a second technique that extracts times at which the vehicle exited from the first sensor unit and the second sensor unit as the first time and the second time, respectively, and calculates the vehicle's average speed, and
a third technique that extracts times at which greatest sensed values caused by the vehicle were detected by the first sensor unit and the second sensor unit as the first time and the second time, respectively, and calculates the vehicle's average speed; and
the computation unit calculates the vehicle's final average speed by comparing similarities among the vehicle's average speeds calculated by the first, second and the third techniques.

6. The apparatus of claim 5, wherein the computation unit calculates an average of the vehicle's two remaining average speeds, obtained by excluding a most different one from the vehicle's average speeds calculated by the first, second and third techniques, as the vehicle's final average speed.

7. A method of generating traffic information, comprising:
collecting first sensed data, including first reference sampled data related to detection of information about a vehicle and a plurality of pieces of first surrounding sampled data obtained before and after the first reference sampled data, from a first sensor unit that samples variations in geomagnetism at a first point of a traffic lane at predetermined intervals;
collecting second sensed data, including second reference sampled data related to detection of information about the vehicle and a plurality of pieces of second surrounding sampled data obtained before and after the second reference sampled data, from a second sensor unit that samples variations in geomagnetism at a second point of the traffic lane at predetermined intervals;
extracting a first time at which the vehicle passed the first sensor unit from the first sensed data;
determining similarity between the first sensed data and the second sensed data by comparing them with each other, and extracting a second time at which the vehicle passed the second sensor unit, corresponding to the first time, from the second sensed data; and
calculating the vehicle's average speed using information about the first time and the second time.

8. The method of claim 7, wherein:
the collecting first sensed data comprises collecting the first sensed data based on a section in which the vehicle had entered the first sensor unit;
the collecting second sensed data comprises collecting the second sensed data based on a section in which the vehicle had entered the second sensor unit;
the extracting first time comprises extracting a time at which the vehicle entered the first sensor unit as the first time; and
the extracting second time comprises extracting a time at which the vehicle entered the second sensor unit as the second time.

9. The method of claim 7, wherein:
the collecting first sensed data comprises collecting the first sensed data based on a section in which the vehicle had exited from the first sensor unit;
the collecting second sensed data comprises collecting the second sensed data based on a section in which the vehicle had exited from the second sensor unit;
the extracting first time comprises extracting a time at which the vehicle exited from the first sensor unit as the first time; and
the extracting second time comprises extracting a time at which the vehicle exited from the second sensor unit as the second time.

10. The method of claim 7, wherein:
the collecting first sensed data comprises collecting the first sensed data using a greatest one of the sensed values, varying while the vehicle was passing the first sensor unit, as the first reference sampled data; and
the collecting second sensed data comprises collecting the second sensed data using a greatest one of the sensed values, varying while the vehicle was passing the second sensor unit, as the second reference sampled data.

11. The method of claim 7, wherein the collecting first sensed data, the collecting second sensed data, the extracting first time, and the extracting second time are performed using:
a first technique that extracts times at which the vehicle entered the first sensor unit and the second sensor unit as the first time and the second time, respectively, and calculates the vehicle's average speed,
a second technique that extracts times at which the vehicle exited from the first sensor unit and the second sensor unit as the first time and the second time, respectively, and calculates the vehicle's average speed, and
a third technique that extracts times at which greatest sensed values caused by the vehicle were detected by the first sensor unit and the second sensor unit as the first time and the second time, respectively, and calculates the vehicle's average speed; and
the calculating the vehicle's average speed comprises calculating the vehicle's final average speed by comparing similarities among the vehicle's average speeds calculated by the first, second and the third techniques.

12. The method of claim 11, wherein the calculating the vehicle's average speed comprises calculating an average of the vehicle's two remaining average speeds, obtained by excluding a most different one from the vehicle's average speeds calculated by the first, second and third techniques, as the vehicle's final average speed.
